(19) United States
(12) Patent Application Publication
(10) Pub. No.: US 2006/0261561 A1
(43) Pub. Date: Nov. 23, 2006

(54) Flat gasket, in particular cylinder-head gasket

(76) Inventor: Markus Heilig, Betzdorf (DE)

Correspondence Address: Robert L Stearns;Howard & Howard Attorneys, 39400 Woodward Avenue, Suite 101, Bloomfield Hills, MI, 48304-5151, US

(21) Appl. No.: 10/549,068

(22) PCT Filed: Feb. 26, 2004
(86) PCT No.: PCT/DE04/00358

§ 371 Date: Sep. 12, 2005

(30) Foreign Application Priority Data
Mar. 12, 2003 (DE) 103 10 683.9

(51) Int. Cl. F02F 11/00

(52) U.S. Cl. 277/593

(57) ABSTRACT

The invention relates to a flat gasket, in particular a cylinder-head gasket for internal combustion engines, comprising at least one support element, in particular a metallic element, which is provided with at least one passage on the combustion chamber side. According to the invention, the passage is surrounded by a concentric stopper element and at least one concentric elastic half-bead that is inserted into a metallic functional layer. The half-bead lies in a direct force fit against the stopper element, the latter having a greater thickness than that of the support element.

The invention relates to a flat gasket, in particular a cylinder-head gasket for internal combustion engines.

A metallic cylinder-head gasket with at least one sealing layer is described in DE-A 198 09 755, which includes an opening for a chain case and an edge section that is neighboring said opening, whereby an elastic sealing element is incorporated around the opening, fully or partially extending over the edge section. The edge section incorporates a support unit for the elastic sealing element that can be a bead or a half bead.

Japanese Patent No. JP-A 06117542 discloses a metallic flat gasket that incorporates various passages within one metallic layer. Both full and half beads are arranged as sealing elements in the region of the passages.

Today's internal combustion engines frequently make use of cylinder-head gaskets which incorporate embossed spring-steel full beads for long-lasting elastic sealing of the combustion chamber. An outstanding feature of the full beads is that starting from a base surface on the plate a protrusion is formed in one direction, so that a sealing contact line (bead ridge) to the side directly opposed to the base surface is created. Full beads are supported on the base surface level by so-called bead feet which are arranged on both sides of the bead ridge, that is, two sealing contact lines are formed on the base surface level. This basic full bead construction has a minimum requirement in terms of sectional space and can only be formed using relatively complex embossing tools.

It is therefore an object of the present invention to provide a flat gasket, in particular a cylinder head gasket, for extremely limited space conditions in the area of the combustion chamber seal, while retaining the known functional features at reduced tooling requirements.

This object and others to become apparent as the specification progresses are accomplished by the invention, according to which a flat gasket, in particular a cylinder-head gasket for internal combustion engines, comprising at least one support element, in particular a metallic element, which is provided with at least one opening on the combustion chamber side. According to the invention, the passage is surrounded by a concentric stopper element and at least one concentric elastic half bead that is inserted into a metallic functional layer. Said half bead lies in a direct force fit against the stopper element, the latter having a greater thickness than that of the support element.

In comparison to a full bead, the new sealing concept for combustion chambers presented in this invention comprises stopper elements as well as half beads that can be mechanically linked thereto, especially in the case of limited space conditions.

The elastic sealing of each combustion chamber is achieved by way of a generally concentric half bead of predetermined width and height that completely encircles the exterior side of the gasket aperture. The dimensions are determined by the particular application. Half bead widths of 0.8 to 2.5 mm and heights between 0.05 and 1.0 mm are typical.

The combustion chamber half bead is advantageously embossed into spring-steel layers (functional layers) of the flat gasket, in particular of the cylinder-head gasket. The number of embossed spring steel layers can be varied in accordance with the dynamic requirements of the respective internal combustion engine.

The combustion chamber half bead is located, as already mentioned, in a direct force fit against the combustion chamber sealing area (stopper element), the latter having a greater thickness than that of the support element. Such stopper elements prevent a further reduction of the sealing gap height in its installed state (operational state). Stopper elements can be constructed, for example, by welding additional sheet sections onto a layer, e.g. the support element of the flat gasket. Other embodiments may provide sintered-on materials, glued-on synthetic materials or others. The gasket thickness shall preferably be 0.04 to 0.20 mm thicker in the area of the combustion chamber half bead than in the other areas. The localized increase in thickness achieved in this way enables the clamping force provided by the cylinder head screws to be primarily employed to apply pressure on the half bead and, consequently, for sealing the combustion chamber. The thickness of this area determines not only the distribution of the claming force and related sealing properties, but also the distortion of the motor component parts, which behave inversely to the sealing pressure. The width of the stopper element is determined to a great extent by the width of the combustion chamber half bead arranged on the area covered by said stopper element. Widths ranging from 1 to 4 mm are typically used. This arrangement does not exclude the possibility that the areas covered by the stopper elements of neighboring cylinders flow into one another, thus creating a spectacle shape when viewed from above.

The combustion chamber half bead can be constructed using a relatively simple stepped tool. Such tools can be manufactured cost-effectively and are easy to service and readjust.

A further object of the present invention is to provide a flat gasket, in particular a cylinder-head gasket, comprising a layered construction in accordance with the requirements of the individual motor. A further preferred embodiment of the present invention is provided with a combination of two inversely beaded spring-steel layers and a support element that incorporates the stopper element. It is recommended to construct the support element carrying the stopper element with one flat side and that this flat side is directed towards one of the motor parts, preferably the cylinder crankcase. An outer sealing surface of this type is

capable of covering irregularities in the crank case surface, such as sinkholes and pores, without affecting the sealing properties of said surface. Typical thicknesses for stopper elements carrying support elements are between 0.1 and 0.5 mm. For an even number of spring-steel layers it is important that the opposing layers comprising half beads are arranged so that the half bead flanks projecting out of the sealing plane abut the combustion chamber edge of the corresponding motor component part. This can provide a certain increase of the sealing pressure through deflection of the flanks under the influence of gas pressure.

The present invention is shown by means of an exemplary embodiment in the appended drawings and will be further explained in the following. In the drawings:

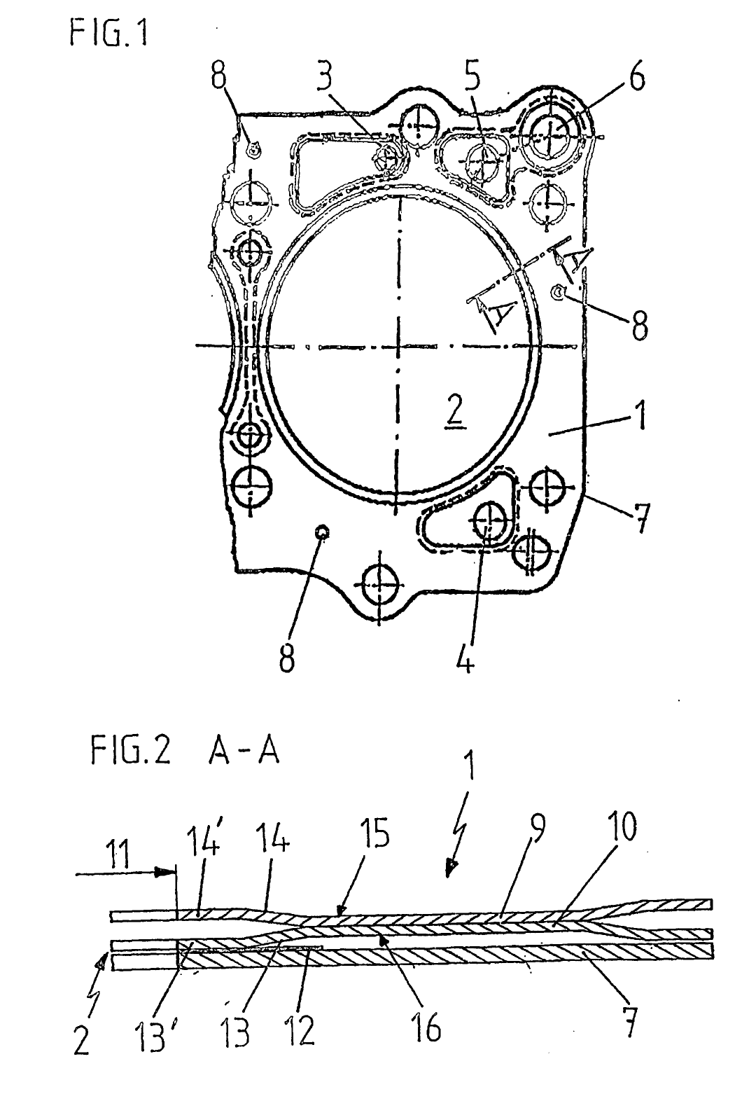

FIG. 1 is a plan view of a cylinder-head gasket;

FIG. 2 is a sectional view along line A-A in FIG. 1;

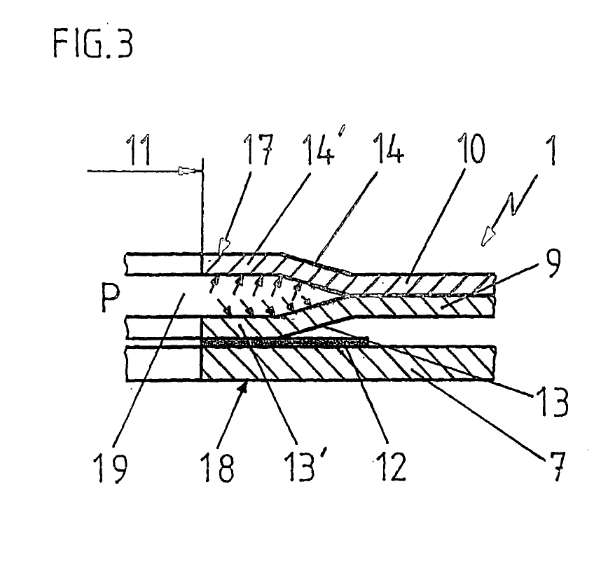

FIG. 3 is a simulation of a cylinder-head gasket in its installed state (operational state) in accordance with FIGS. 1 and 2.

FIG. 1 shows a cylinder-head gasket 1 with an aperture 2 for the combustion chamber and liquid passage openings 3,4,5,6 for the coolant on one side and for the lubricant on the other side. The cylinder-head gasket 1 comprises a metallic support element 7 and functional layers connected with it by means of the rivets 8, said functional layers not being visible here but shown in more detail in the following figures. FIG. 2 provides a sectional view through the cylinder-head gasket 1 according to FIG. 1. The support element 7 is shown together with two spring-steel layers 9, 10 acting as functional layers. Reference number 11 identifies the border edge of the combustion chamber, which also acts as the border edge of both the support element 7 and the functional layers 9, 10. On the side of the combustion chamber the support element 7 is connected with a stopper element 12, for example by welding, so that the stopper element 12 encircles the passage 2 with predetermined width and thickness. The elastic seal of the aperture 2 on the side of the combustion chamber is hereby provided by a half bead 13,14 arranged concentrically around the aperture 2, said half bead equally featuring a predetermined width and height. The respective half bead 13, 14 is embossed into the functional layers which are constructed as spring-steel layers. This exemplary embodiment provides a combination of two inversely beaded functional layers 9, 10 and a support element 7 carrying a stopper element 12, where it will be apparent that alternatives with a plurality of spring-steel layer (pairs) are also possible in relation to upper and lower support elements.

If, as shown in this example, an even number (two) of spring-steel layers 9, 10 is to be applied, then care must be taken to arrange the two opposed functional layers 9, 10 comprising the half beads 13, 14 so that the flanks 13′, 14′ of the half beads 13, 14 protruding from the individual plane 15, 16 are not abut to the motor component parts not shown here. The thickened area created by the stopper element 12 on the side of the combustion chamber enables the clamping force provided by the cylinder head screws, which are no longer shown, to be primarily employed to apply pressure on the half beads 13, 14 and consequently, for sealing the combustion chamber The width of the thickened area determines to a great extent the clamping force distribution and, with it, the sealing properties. FIG. 3 shows a cutout of FIG. 2 illustrating the sealing area on the side of the combustion chamber. The support element 7, the functional layers 9, 10, the stopper element 12 and the combustion chamber area are clearly visible. The figure shows a simulation of the cylinder-head gasket 1 in its installed state. P indicates the alternating pressure in the combustion chamber applied from the combustion chamber side. The reference numbers 17, 18 represent both the sealing areas on the cylinder head and on the motor block, respectively. Tightening of the here no longer shown cylinder head screws results in the closing of the gap 19 between the half beads 13, 14, whereby total closure is never achieved due to the existing elastic properties of the half beads 13, 14. Moreover, the stopper element 12, or rather the thickness of its material, prevents the complete closure of the gap 19. The adjacent gas at the pressure P can now

pass through the gap 19 and expand the flanks 13′, 14′ again towards the sealing surfaces 17, 18. This provides a pre-definable increase of the sealing pressure by deflecting the half beads 13, 14 in relation to the flanks 13′, 14′.

1. Flat gasket, in particular a cylinder-head gasket for internal combustion engines, comprising at least one metallic support element having at least one passage being surrounded by a stopper element arranged concentrically thereto and also by at least one elastic half-bead arranged concentrically thereto that is inserted into at least one metallic functional layer, said half bead lying in a direct force fit against said stopper element, the latter having a greater thickness than that of the said support element.

2. Flat gasket according to in claim 1, herein said half beads are embossed, at least on the side of the passages, into a plurality of metallic function allayers.

3. Flat gasket according to claim 2, wherein in the case of an even number of functional layers their respective said half beads are disposed in opposite directions.

4. Flat gasket according to claim 3 wherein said functional layers, being beaded in opposite directions, are positioned one above another to form a gap directed towards the gasket aperture.

5. Flat gasket according to claim 1, wherein said support element is of a substantially planar construction outside said stopper element.

6. Flat gasket according to claim 5, wherein said support element is constructed of stainless steel material and said metallic functional layers, including said half beads, are constructed of spring-steel material.

7. Flat gasket according to claim 1, wherein said stopper element is wider than said corresponding half bead.
